(19) United States
(12) Patent Application Publication
(10) Pub. No.: US 2023/0174133 A1
(43) Pub. Date: Jun. 8, 2023

(54) TRACKED STROLLER FRAME DEVICE

(71) Applicant: Kent Galbraith, Ontario, CA (US)

(72) Inventor: Kent Galbraith, Ontario, CA (US)

(21) Appl. No.: 18/102,715

(22) Filed: Jan. 29, 2023

Related U.S. Application Data
(63) Continuation-in-part of application No. 16/907,769, filed on Jun. 22, 2020, now abandoned.

(51) Int. Cl. B62B 7/06; B62D 55/07; B62B 9/20

(52) U.S. Cl. CPC B62B 7/064; B62D 55/07; B62B 9/20; B62B 2301/256

(57) ABSTRACT

The tracked stroller frame device may allow a user to take a stroller with them when camping, hiking, or otherwise travelling over rough terrain. The device implements a continuous track system for providing additional tractive area and reducing or eliminating getting stuck on uneven surfaces, and may include a motorized mechanism for providing driving force. The tracked stroller device allows a user to take a baby or young child with them without carrying the baby or young child. The device may be collapsible for ease of storage and transporting and may incorporate a storage area to allow for transporting of other items. A braking system may also be implemented to slow down the device or keep it parked.

### TECHNICAL FIELD OF THE INVENTION

The present invention relates in general to stroller devices, and, more specifically, to a tracked stroller frame device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A stroller, or a baby stroller, is a wheeled chair device used, generally, for transporting babies and young children. Strollers tend to comprise one or more seats into which a baby or child can be seated and belted in, and the one or more seats are attached to a stroller frame that, often, is collapsible. By such a design a stroller can be hauled around inside of a vehicle and deployed where needed. The frame is attached to wheels, some of which may be steerable, allowing a person to push the stroller and passenger around as desired. Due to their common design strollers are effective at operating on smooth or paved surfaces and some mildly uneven surfaces.

Some persons, especially those fond of camping, hiking, and other outdoor activities, are not able to take strollers along with them to transport their children due to excessively uneven terrain. One common baby-transporting solution for operating over uneven terrain is a baby carrier backpack, which may comprise a saddle for holding the passenger and a plurality of storage areas for carrying other goods. Some such backpacks may even be convertible into sitting areas for the child when not on the move. Such a solution, though, necessarily requires a person to carry the backpack and the baby, and such carrying often leads to fatigue due to the additional weight.

A better solution for traversing uneven terrain with a child includes installing larger wheels, usually having traction devices, onto the stroller. Such larger wheels may reduce the likelihood that the stroller would become stuck in uneven terrain, but such wheels, where they can even be installed, tend to increase the folded size of the stroller or even prevent it from being folded for storage and transporting. Also, such wheels, while improving the stroller's uneven terrain capabilities, can still become stuck between rocks and within gaps that are larger than the wheels themselves.

The optimal solution for uneven surface travel is known to exist within the continuous tracked suspension concept. Such a suspension provides the benefit of a very large terrain contact surface for providing tractive effort and preventing becoming stuck in gaps. No solution exists, though, for adapting a continuous tracked suspension to a baby stroller for traversing uneven terrain.

Thus, there is a need in the art for a tracked stroller frame device that may allow a user to transport a baby or child over uneven terrain without carrying. Such a solution may also be collapsible so that it is easily stored and transported, and may include a drive motor to aid in traversing terrain or becoming unstuck. It is to these ends that the present invention has been developed.

### BRIEF SUMMARY OF THE INVENTION

To minimize the limitations in the prior art, and to minimize other limitations that will be apparent upon reading and understanding the present specification, the present invention describes a tracked stroller frame device.

It is an objective of the present invention to provide a tracked stroller frame device that may comprise a baby stroller.

It is another objective of the present invention to provide a tracked stroller frame device that may comprise a suspension assembly.

It is another objective of the present invention to provide a tracked stroller frame device that may comprise a seat frame assembly.

It is another objective of the present invention to provide a tracked stroller frame device that may comprise a collapsible seat frame assembly.

It is another objective of the present invention to provide a tracked stroller frame device that may comprise a plurality of track assemblies.

It is another objective of the present invention to provide a tracked stroller frame device that may comprise a plurality of control arms.

It is another objective of the present invention to provide a tracked stroller frame device that may comprise a plurality of fairings.

It is another objective of the present invention to provide a tracked stroller frame device that may comprise a plurality of idler rollers.

It is another objective of the present invention to provide a tracked stroller frame device that may comprise a plurality of geared rollers.

It is another objective of the present invention to provide a tracked stroller frame device that may comprise a plurality of tracks.

It is another objective of the present invention to provide a tracked stroller frame device that may comprise a plurality of kicker motors.

It is another objective of the present invention to provide a tracked stroller frame device that may comprise a plurality of motorized rollers.

It is another objective of the present invention to provide a tracked stroller frame device that may comprise a power source.

It is another objective of the present invention to provide a tracked stroller frame device that may comprise a battery pack.

It is another objective of the present invention to provide a tracked stroller frame device that may comprise a plurality of motors.

It is another objective of the present invention to provide a tracked stroller frame device that may comprise a wireless remote.

It is another objective of the present invention to provide a tracked stroller frame device that may comprise a wireless remote receiver.

It is another objective of the present invention to provide a tracked stroller frame device that may comprise a braking system.

It is another objective of the present invention to provide a tracked stroller frame device that may comprise a resilient material of construction.

It is another objective of the present invention to provide a tracked stroller frame device that may comprise a water-proof material of construction.

It is another objective of the present invention to provide a tracked stroller frame device that may comprise a reusable material of construction.

It is another objective of the present invention to provide a tracked stroller frame device that may comprise a washable material of construction.

It is another objective of the present invention to provide a tracked stroller frame device that may comprise a multi-component construction.

It is another objective of the present invention to provide a tracked stroller frame device that may comprise an antimicrobial layer.

It is another objective of the present invention to provide a tracked stroller frame device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an isometric perspective view of a tracked stroller frame device, as contemplated by the present disclosure;

FIG. 2 is a top plan view of a tracked stroller frame device, as contemplated by the present disclosure;

FIG. 3 is a bottom plan view of a tracked stroller frame device, as contemplated by the present disclosure;

FIG. 4 is a rear perspective view of a tracked stroller frame device, as contemplated by the present disclosure;

FIG. 5 is a front perspective view of a tracked stroller frame device, as contemplated by the present disclosure;

FIG. 6 is a left side elevation view of a tracked stroller frame device, as contemplated by the present disclosure;

FIG. 7 is a right side elevation view of a tracked stroller frame device, as contemplated by the present disclosure;

FIG. 8 is a rear isometric perspective view of a tracked stroller frame device, as contemplated by the present disclosure;

FIG. 9 is an exploded component view of a tracked stroller frame device, as contemplated by the present disclosure;

FIG. 10 is an exploded component view of a track assembly of a tracked stroller frame device, as contemplated by the present disclosure;

FIG. 11 is an isometric perspective view of a seat frame assembly of a tracked stroller frame device, as contemplated by the present disclosure;

FIG. 12 is a left side elevation view of a track and roller combination of a tracked stroller frame device, as contemplated by the present disclosure;

FIG. 13 is an isometric perspective view of a powered embodiment of a tracked stroller frame device, as contemplated by the present disclosure;

FIG. 14 is an exploded component view of a powered embodiment of a tracked stroller frame device showing a power source and wheel motors, as contemplated by the present disclosure; and

FIG. 15 is an isometric perspective view of a wireless controller of a tracked stroller frame device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The tracked stroller frame device may allow a user to take a stroller with them when camping, hiking, or otherwise travelling over rough terrain. The device implements a continuous track system for providing additional tractive area and reducing or eliminating getting stuck on uneven surfaces, and may include a motorized mechanism for providing driving force. The tracked stroller device allows a user to take a baby or young child with them without carrying the baby or young child. The device may be collapsible for ease of storage and transporting and may incorporate a storage area to allow for transporting of other items. A braking system may also be implemented to slow down the device or keep it parked.

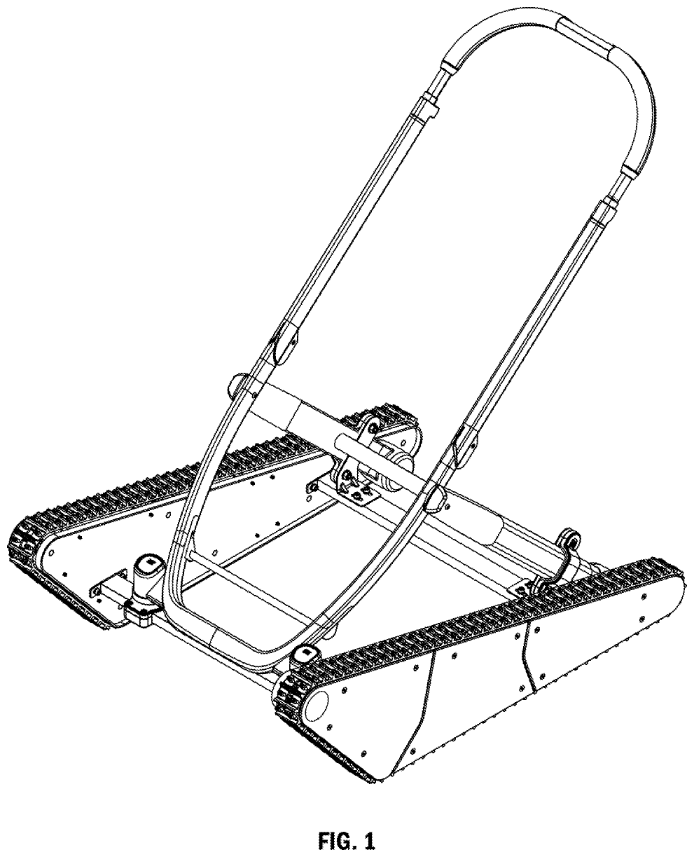

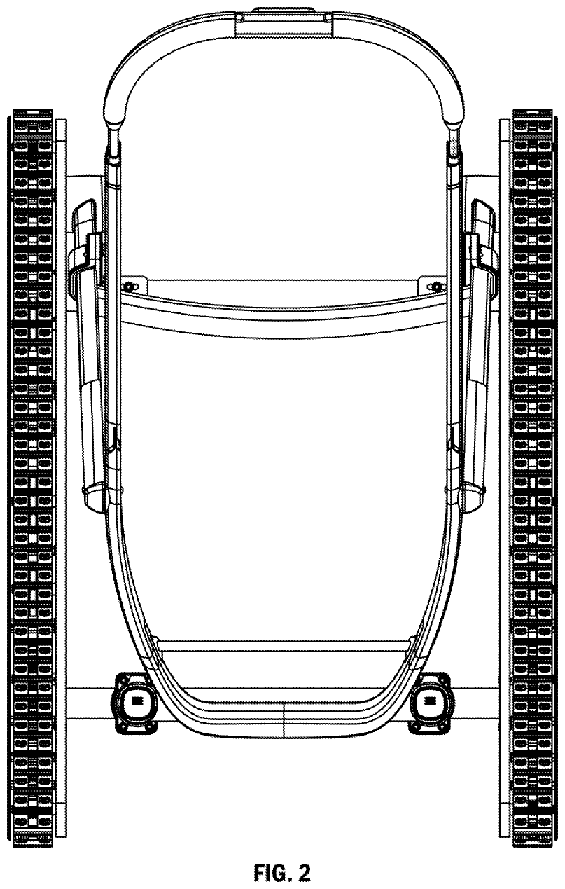

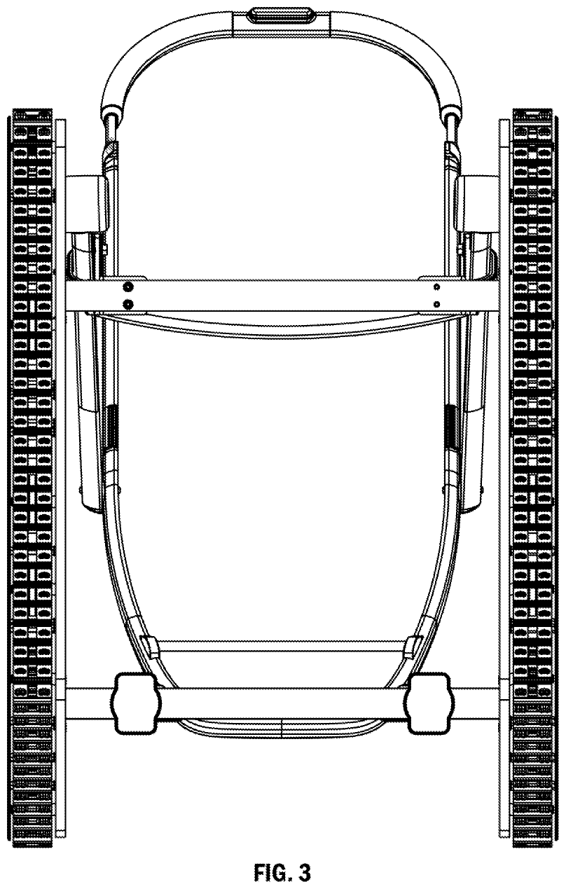

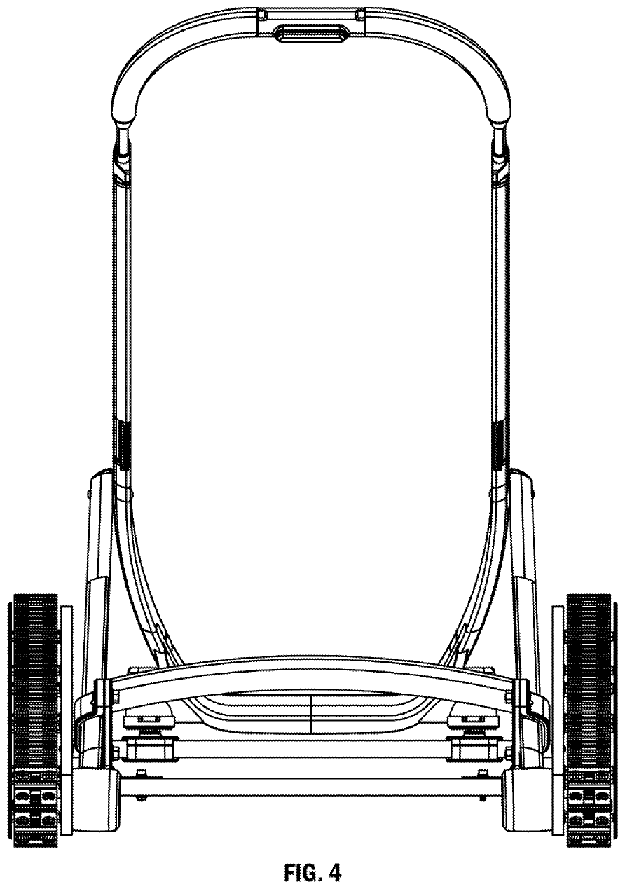

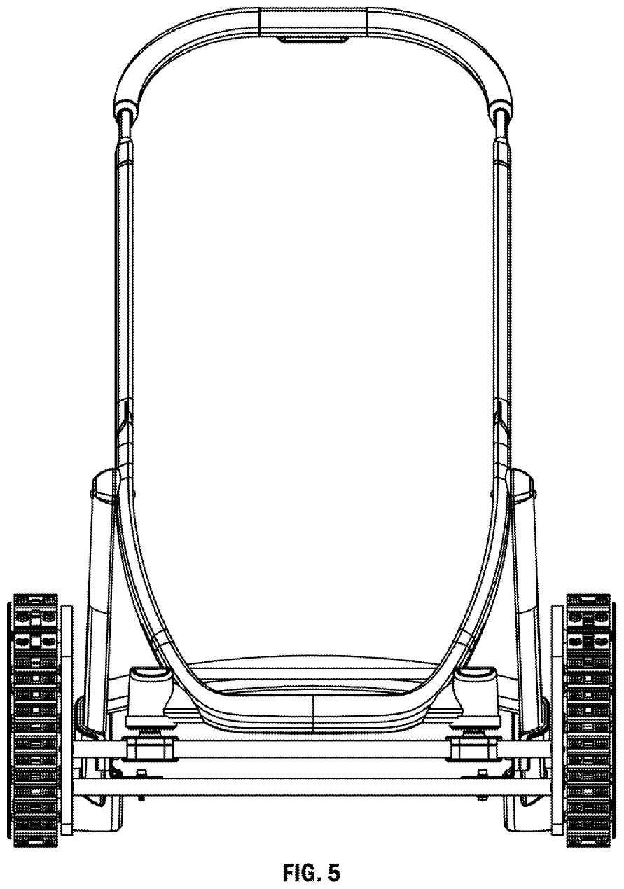

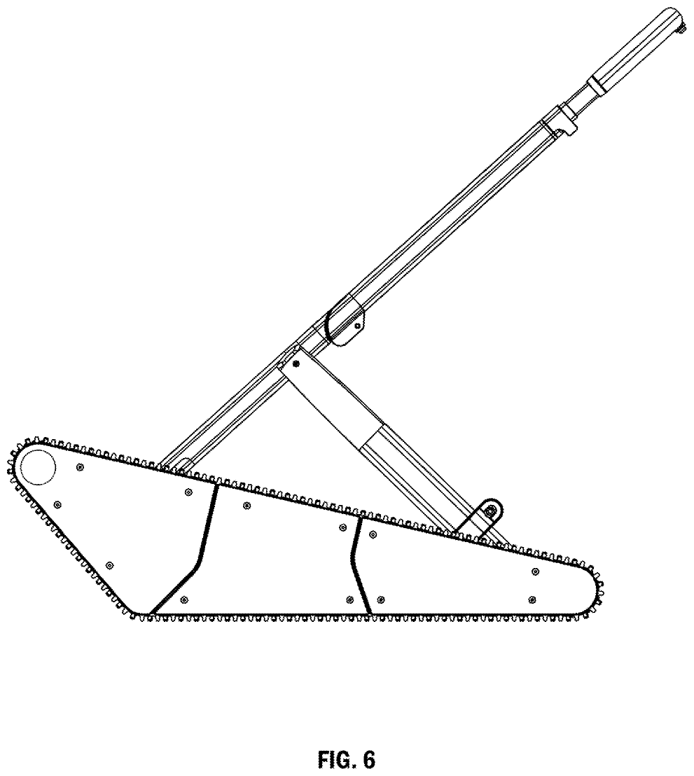

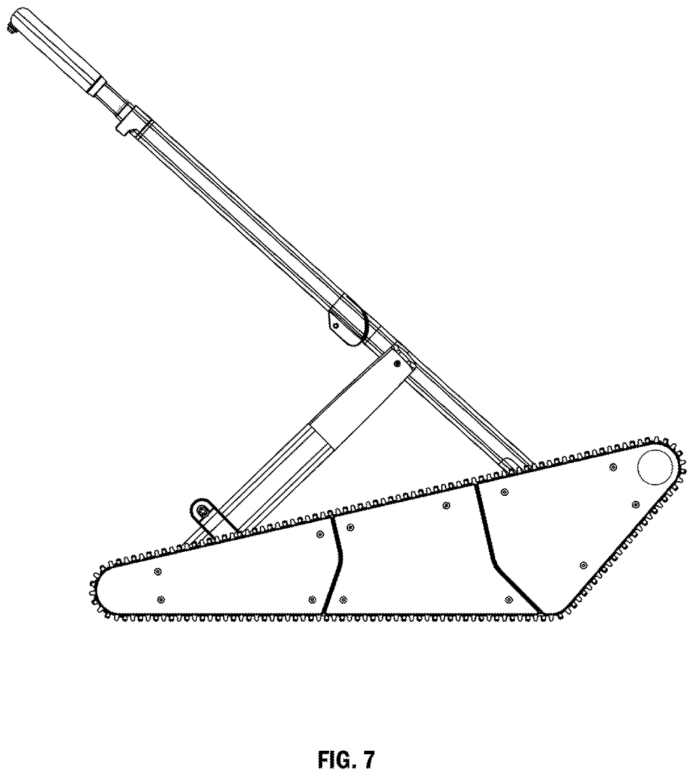

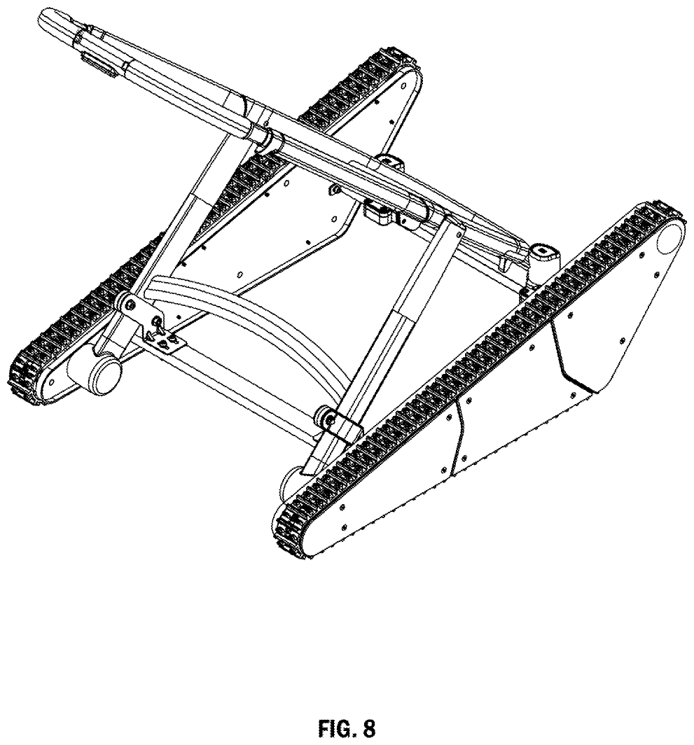

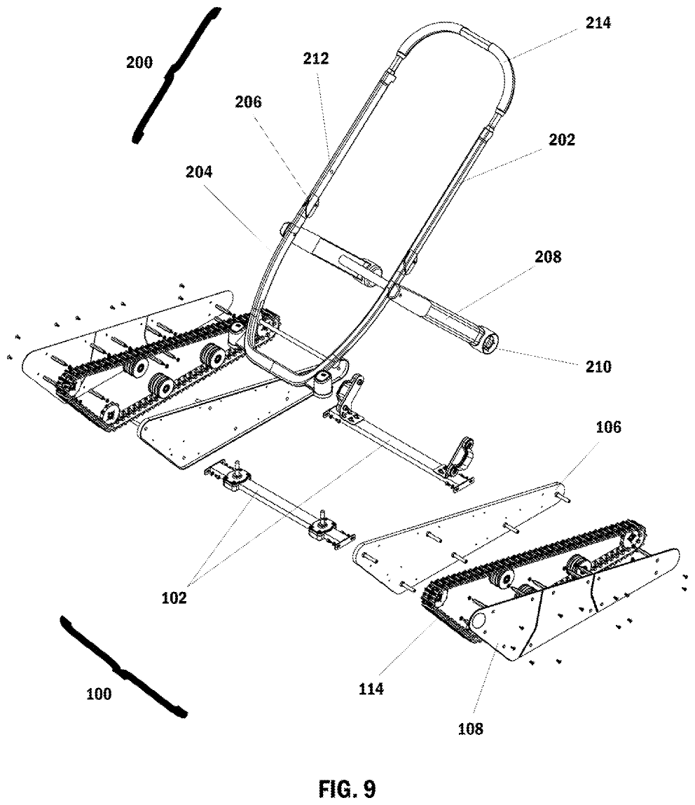

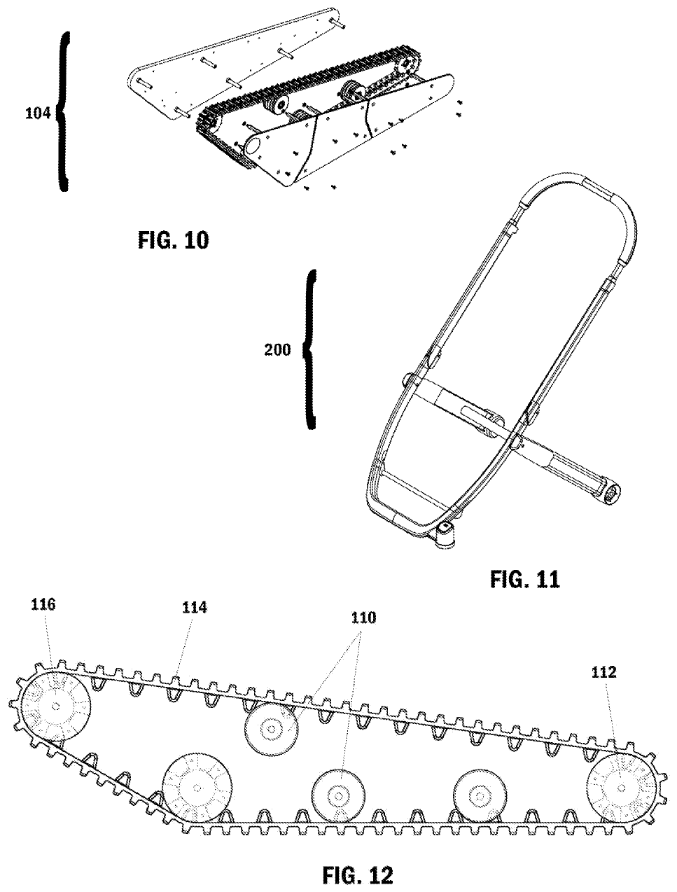

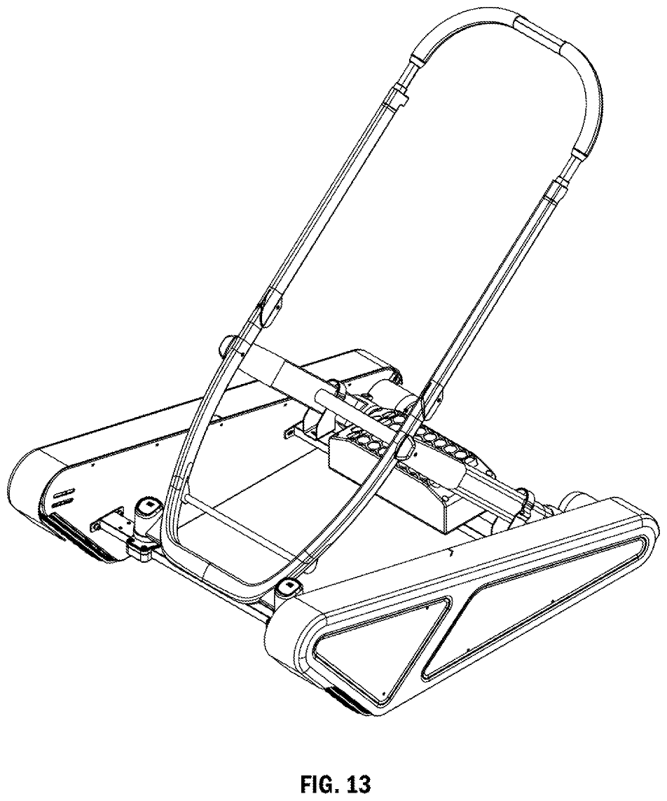

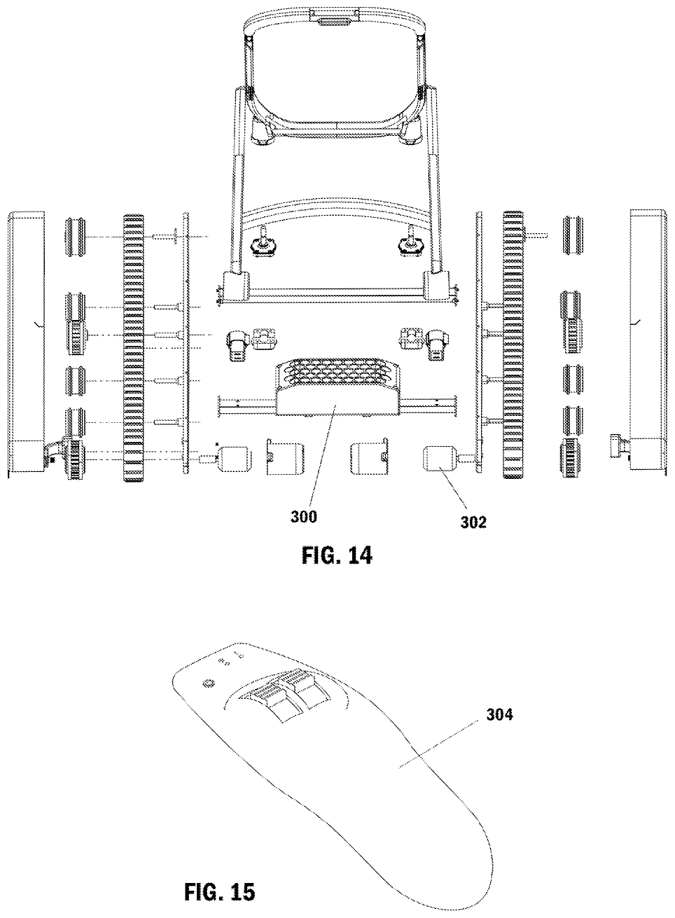

The illustrations of FIGS. 1-15 illustrate a tracked stroller frame device, as contemplated by the present disclosure. The device may comprise, generally, a suspension assembly 100 and a seat frame assembly 200. The suspension assembly 100 is intended to provide a suspension composition that allows the device to traverse uneven terrain, and the seat frame assembly 200 is intended to provide a mounting frame for a standard or proprietary stroller seat. The tracked stroller frame device may further comprise a foldable or collapsible design that allows the seat frame assembly 200 to fold down and be positioned within the area of the suspension assembly 100.

The suspension assembly 100 may comprise a plurality of control arms 102 connecting a plurality of track assemblies 104. One each of the plurality of tracked assemblies 104 may comprise an inner fairing 106, an outer fairing 108, a plurality of rollers, and a continuous track 114. The inner fairing 106 may comprise a cover or plate having a plurality of axle posts or axle post receivers, and the outer fairing 108 may comprise a cover or plate having a plurality of axle posts or axle post receivers complementary to the inner fairing 106. The plurality of axle posts or axle post receivers may further comprise individual suspension components allowing them to articulate relative to the inner fairing 106 and outer fairing 108. The plurality of rollers may be installed onto and held in place by the plurality of axle posts and axle post receivers, and the continuous track 114 may be installed around the plurality of rollers. The plurality of control arms 102 may further comprise a seat frame assembly 200 attachment mechanism.

The inner fairing 106 of the plurality of track assemblies 104 may be positioned relatively inboard to the outer fairing 108 and may be attached to the plurality of control arms 102. The mechanism of attachment between the inner fairing 106 and the plurality of control arms may be by any appropriate physical means such as, for example, welding, bolting, riveting, inserting, or the like. In some embodiments the mechanism of attachment may be rigid so that the inner fairing 106 and plurality of control arms 102 remain at a constant angle to one another. In other embodiments the mechanism of attachment may be flexible or articulating so that the inner fairing 106 and plurality of control arms 102 may articulate relative to one another.

One each of the plurality of rollers of the plurality of track assemblies 104 may comprise a plurality of idler rollers 110, a plurality of geared rollers 112, or a plurality of motorized rollers 116. The plurality of idler rollers 110 may comprise any appropriate idler rollers known in the art, and may further comprise a grooved or slotted outer surface to aid in maintaining continuous track 114 alignment over the plurality of rollers. The plurality of geared rollers 112 may comprise any appropriate geared rollers known in the art, and may further comprise a geared or slotted outer surface engaging a geared or slotted surface on the continuous track 114 such that the plurality of geared rollers 112 turn with the movement of the continuous track 114. The plurality of motorized rollers 116 may comprise any appropriate geared rollers known in the art, and may further comprise a geared or slotted outer surface engaging a geared or slotted surface on the continuous track 114 such that the plurality of motorized rollers 116 cause movement of the continuous track 114 when they are turned. The turning of the plurality of motorized rollers 116 may be effected by a drive motor 302 or hammer mechanism stored within the suspension assembly 100 or built into the plurality of motorized rollers 116.

By way of a first example, the suspension assembly 200 of a particular embodiment may comprise two of a plurality of control arms 102 rigidly attached to two of a plurality of track assemblies 104. The plurality of track assemblies 104 may comprise a plurality of idler rollers 110 and a plurality of geared rollers 112 installed between one each of the inner fairings 106 and outer fairings 108. The continuous track 114 may be installed around the plurality of rollers on both of the plurality of track assemblies 104, and may roll freely when the suspension assembly 200 is pushed or pulled.

By way of a second example, the suspension assembly 200 of a particular embodiment may comprise two of a plurality of control arms 102 attached by articulating mechanisms to four of a plurality of track assemblies 104. The plurality of track assemblies 104 may comprise a plurality of idler rollers 110 and a plurality of geared rollers 112 installed between one each of the inner fairings 106 and outer fairings 108. Two of the plurality of track assemblies 104 may further comprise a plurality of motorized rollers 116. The continuous track 114 may be installed around the plurality of rollers on all four of the plurality of track assemblies 104, and the two motorized of the plurality of track assemblies 104 may drive their respective continuous track 114 while two of the plurality of track assemblies 104 roll freely when the suspension assembly 200 is pushed or pulled.

The seat frame assembly 200 may comprise a seat upper frame 202, a seat lower frame 204, and a plurality of collapsible support arms 208. The seat upper frame 202 and seat lower frame 204 may comprise any appropriate structural frame, such as a u-shaped frame, and may be attached to one another by their legs. The seat upper frame 202 may be attached to the seat lower frame 204 by an articulating hinge 206, such that the seat upper frame 202 and seat lower frame 204 may be folded relative to one another. The mechanism of attachment between the seat upper frame 202 and seat lower frame 204 or between the seat upper frame 202, the seat lower frame 204, and the articulating hinge 206 may be by any appropriate physical means such as, for example, welding, bolting, riveting, inserting, or the like.

The plurality of collapsible support arms 202 may comprise any appropriate support arms, and may further comprise a locking post 210 designed to engage the suspension assembly 100. The plurality of collapsible support arms 202 may comprise a straight rod arm having a first end and a second end. The first end of one each of the plurality of collapsible support arms 202 may be attached to the seat lower frame 204 by an articulating mechanism, and the second end of one each of the plurality of collapsible support arms 202 may comprise the locking post 210. The locking post 210 may be swung into position relative to the suspension assembly 100 when the seat frame assembly 200 is unfolded, and the locking post 210 may engage the suspension assembly 100 by any appropriate reversible attachment mechanism. The reversible mechanism of attachment between the locking post 210 and the suspension assembly 100 may be by any appropriate physical means such as, for example, inserting, bolting, snapping, binding, or the like.

The seat frame assembly 200 may further comprise a seat receiver 212, which may comprise any appropriate mechanism for receiving a standard or proprietary stroller seat. The seat receiver 212 may comprise any appropriate reversible attachment mechanism. The reversible mechanism of attachment between the seat receiver 212 and the standard or proprietary stroller seat may be by any appropriate physical means such as, for example, inserting, bolting, snapping, binding, or the like.

The seat frame assembly 200 may further comprise a handgrip 214, which may comprise any appropriate padded surface or cover on the seat upper frame 202 intended to cushion or pad the gripping area of the seat frame assembly 200.

The seat frame assembly 200 may further comprise a drive switch, which may comprise any appropriate switch or throttle control mechanism intended to control the plurality of motorized rollers 116 when equipped on a particular embodiment.

In one embodiment the tracked stroller frame device may further comprise a control module 300, which may itself comprise a battery, a wireless remote receiver, and other electronic components appropriate to obtaining the objective of the control module 300. The control module 300 may store and provide electrical power to the device and may receive a plurality of signals from a wireless remote 304. The battery of the control module 300 may be rechargeable and may provide power to a plurality of wheel motors 302. Providing such power to the plurality of wheel motors 302 may allow the plurality of wheel motors 302 to create rotational torque that is applied to one or more of the plurality of motorized rollers 116 or one or more of the plurality of geared rollers 112 so as to drive continuous track 114. In some embodiments the plurality of wheel motors 302 on one side of the device may be able to move independently of the plurality of wheel motors 302 on the other side of the device to allow for turning of the device and fine motor control.

In one embodiment the control module 300 may be wirelessly connected to a wireless remote 304 by a wireless remote receiver. The wireless remote 304 may provide a user with the ability to wirelessly control the plurality of wheel motors 302 of the device. The wireless remote 304 may comprise a single gimbal that allows for a three-hundred and sixty degree range of motion that is interpreted by the wireless remote receiver to differentially brake or accelerate the plurality of wheel motors 302 and cause the device to drive forward, backward, or turn in any direction. The wireless remote 304 may, instead, comprise a plurality of control levers that allow the user to independently control the plurality of wheel motors 302 on the left side of the device or the plurality of wheel motors 302 on the right side of the device.

The tracked stroller frame device may further comprise a braking system, which may comprise any system appropriate for applying braking or locking force to the plurality of track assemblies 104. By way of example, the braking system may comprise a plurality of disc brakes, a plurality of drum brakes, a plurality of electric motor brakes, or the like.

The seat frame assembly 200 may further comprise a brake switch, which may comprise any appropriate switch or level intended to apply braking or locking force to the plurality of track assemblies 104 when a braking system is equipped on a particular embodiment.

The tracked stroller frame device may further comprise a storage system, which may comprise any system appropriate for providing storage areas within or on the device. In one embodiment the storage system may comprise a netting attached to the seat frame assembly 200 or the plurality of controls arms 102. In a second embodiment the storage system may comprise a satchel, bag, or other soft container attached to the seat frame assembly 200.

The tracked stroller frame device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the tracked stroller frame device may be substantially constructed of one or more materials of silicone, plastic, acrylic, polycarbonate, steel, aluminum, brass, fiberglass, carbon fiber, or combinations thereof. In some embodiments the various components of the device may be coated, lined, or otherwise insulated to prevent contamination of the device. In one embodiment the material of construction may vary from one component to the next within the system.

In one embodiment the tracked stroller frame device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A tracked stroller frame device, comprising:
a plurality of control arms;
a plurality of track assemblies; and
a seat frame assembly;
wherein said plurality of control arms are attached to one each of said plurality of track assemblies; and
wherein said seat frame assembly is attached to said plurality of control arms.

2. The invention of claim 1,
wherein one each of said plurality of track assemblies further comprises an inner fairing, an outer fairing, a plurality of axle posts, a plurality of rollers, and a continuous track;
wherein said inner fairing is attached to said outer fairing by said plurality of axle posts;
wherein one each of said plurality of rollers is installed on one each of said plurality of axle posts; and
wherein said continuous track is installed on said plurality of rollers.

3. The invention of claim 2,
wherein said seat frame assembly further comprises a seat upper frame, a seat lower frame, and a plurality of collapsible support arms;
wherein said seat upper frame is attached to said seat lower frame; and
wherein said plurality of collapsible support arms are attached to said seat lower frame.

4. The invention of claim 3,
wherein said seat upper frame is attached to said seat lower frame by an articulating hinge.

5. The invention of claim 4,
wherein said seat frame assembly further comprises a seat receiver mechanism.

6. The invention of claim 5, further comprising:
a stroller seat.

7. The invention of claim 5,
wherein one each of said plurality of rollers is selected from a group consisting of an idler roller, a geared roller, and a motorized roller.

8. The invention of claim 5,
wherein said plurality of control arms are attached to one each of said plurality of track assemblies by a rigid attachment mechanism.

9. The invention of claim 5,
wherein said plurality of control arms are attached to one each of said plurality of track assemblies by an articulating attachment mechanism.

10. The invention of claim 5,
one each of said plurality of axle posts further comprises a suspension mechanism.

11. The invention of claim 5, further comprising:
a braking system.

12. The invention of claim 5, further comprising:
a storage area.

13. The invention of claim 5, further comprising:
a motor.

14. The invention of claim 5, further comprising:
a control module;
wherein said control module further comprises a battery.

15. The invention of claim 14, further comprising:
a wireless remote; and
a wireless remote receiver;
wherein said wireless remote receiver is attached to said control module; and
wherein said wireless remote is wirelessly connected to said wireless remote receiver.
